(19) United States
(12) Patent Application Publication
(10) Pub. No.: US 2014/0318187 A1
(43) Pub. Date: Oct. 30, 2014

(54) GLASS MELTING METHOD AND MOLTEN GLASS LAYER BUBBLING GLASS MELTING FURNACE

(71) Applicant: THE FEDERAL STATE AUTONOMOUS EDUCATIONAL INSTITUTION OF THE HIGHER PROFESSIONAL EDUCATION, Moscow (RU)

(72) Inventors: Gleb Semenovich Sborshikov, Moscow (RU); Juriy Dgimovich Klegg, Vladimirskaya oblast (RU); Svetlana Victorovna Grishaeva, Moscow (RU); Dmitriy Jurievich Klegg, Vladimirskaya oblast (RU)

(21) Appl. No.: 14/363,435

(22) PCT Filed: Dec. 3, 2012
(86) PCT No.: PCT/RU2012/001011

§ 371 Date: Jun. 6, 2014

(30) Foreign Application Priority Data
Dec. 8, 2011 (RU) 2011149967

(51) Int. Cl. C03B 5/193

(52) U.S. Cl. CPC C03B 5/193
USPC 65/134.6; 65/347

(57) ABSTRACT

This invention relates to the continuous production of molten glass for further production of glassware and can be used for glass melting and obtaining glass semiproduct. The technical objective of this invention is to provide a method and a furnace for producing molten glass with stabilized physical properties due to an increased phase boundary area, higher temperature in the glass furnace bath and intensified mixing as well as due to a higher output of the glass furnace. Molten glass layer bubbling glass melting method comprising melting the glass layer in the first chamber of the furnace to the working level, further uninterrupted loading of large and small charge portions into the molten glass layer with simultaneous intense bubbling of the molten glass layer with high-temperature combustion products aiming at the formation of the maximum possible charge/molten glass phase boundary area and achieving a molten glass temperature of at least 1500° C., which conditions intensify the melting, silicate formation, vitrification and homogenizing processes, delivery of the chemically and thermally homogeneous molten glass produced by bubbling to the degassing and cooling section located under the bubbled molten glass layer, with an intense release from the molten glass layer of process gases that pass through the bubbled layer to the space above the layer where the process gases undergo primary cleaning and cooling, and the degassed molten glass is delivered to the further output section.

### FIELD OF INVENTION

This invention relates to the continuous production of molten glass for further production of glassware and can be used for glass melting and obtaining glass semiproduct.

### BACKGROUND OF THE INVENTION

Known are glass melting and degassing method and device (RU 2246454, publ. 20 Feb. 2005) comprising at least one melting chamber equipped with natural gas and oxidizer (e.g. air or oxygen) fueled burners arranged so that to direct the combustion product gases to the molten glass bulk below the level of glass loaded into said melting chamber. Said device delivers molten glass for degassing in the form of a thin layer. The degassing section is a steady state unit and comprises a molten glass discharge channel comprising a groove and a roof.

Disadvantages of said known invention include burner installation inside or outside the melting chamber which does not allow controlling fuel combustion and hence maintaining the required combustion temperature and chemical composition.

Known are glass melting and degassing method and device (FR 2888577, publ. 19 Jan. 2007) comprising side walls, a roof, a front wall and at least one air nozzle with at least one liquid or gaseous fuel nozzle. At least one of said nozzles is located on said side walls, roof or front wall. The furnace delivers air and liquid or gaseous fuel through said nozzles, and each flame torch is only produced in the vicinity of the area where the powdered raw material covers the molten glass.

Disadvantages of said known invention include submersible fuel combustion mode causing fuel overconsumption and not allowing one to control fuel combustion.

The prototype of this invention is the vitrifying material melting method and device (US 2005039491, publ. 24 Feb. 2005) in which molten glass is produced in a mixing module equipped with at least one mixing tool in the form of bubblers or submersible burners.

Disadvantages of said known invention include the presence of at least two separate melting modules and the use of submersible burners for mixing and electrodes for melting. However, these operations can be achieved in a single module by blowing combustion products to under the melt level.

### DISCLOSURE OF THE INVENTION

The technical objective of this invention is to provide a method and a furnace for producing molten glass with stabilized physical properties due to an increased phase boundary area, higher temperature in the glass furnace bath and intensified mixing as well as due to a higher output of the glass furnace.

The invention will be explained hereinbelow with examples of molten glass layer bubbling glass melting method and a furnace for the implementation of this method.

The molten glass layer bubbling glass melting method comprises melting the glass layer in the first chamber of the furnace to the working level, followed by uninterrupted loading of large and small charge portions into the molten glass layer with simultaneous intense bubbling of the molten glass layer with high-temperature combustion products aiming at the formation of the maximum possible charge/molten glass phase boundary area and achieving a molten glass temperature of at least 1500° C.

These conditions intensify the melting, silicate formation, vitrification and homogenizing processes in the molten glass layer.

Then the chemically and thermally homogeneous molten glass produced by bubbling is delivered to the degassing section and the coolers located under the bubbled molten glass layer.

The molten glass layer intensely releases process gases that pass through the bubbled layer to the space above the layer.

The process gases undergo primary cleaning and cooling in that space. The degassed molten glass is delivered to the output section.

The molten glass layer bubbling glass furnace has a wall limited working space that is rectangular in cross-section and is separated into chambers.

The outer side of the side walls in the bottom part of the first rectangular chamber has horizontal tuyers for the delivery of fuel combustion products and dust charge fraction to the molten glass layer.

Each tuyer has a fuel combustion chamber at its outer side.

The walls of the first chambers are in the form of tubular metallic caissons with forced cooling and protective refractory packing at the working side.

The second chamber is located under said first chamber, and the third chamber is adjacent to one of the butt side walls of said first chamber from the outside. Said second and third chambers are interconnected with an overflow channel located in the furnace bottom section.

Said third chamber is equipped with a molten glass discharge unit. The walls of said second and third chambers are made from refractory materials.

Above said first chamber, there is the fourth chamber interconnected with said first chamber, its walls consisting of tubular metallic caissons with forced cooling and protective refractory packing at the working side. The tubular metallic caissons of said fourth chamber that form its ceiling and butt wall facing said third chamber are combined into a radiation air heater in which the input manifold is connected to an air blower and the output manifold is connected to the air ducts of fuel combustion chamber mixers.

A heat recovery boiler connected to the output of the fourth chamber is installed outside the furnace working space at the side of said chamber. A device for loading large charge fractions into the first chamber is installed at the butt wall of the fourth chamber opposite to the third chamber, said device being equipped with a sloped gravity slide in the form of a forced cooled metallic structure with refractory packing at the working side.

Said Myers for the delivery of fuel combustion products and dust charge fraction to the molten glass layer are connected to the pneumatic transporter for the delivery of dust charge fraction.

Said fuel combustion chamber further comprises a nozzle, a working chamber and a mixer and is water cooled.

Coolant delivery to and discharge from said nozzle are separate from the rest of said fuel combustion chamber, and the delivery of heated air to the mixer is tangential.

Said combustion chamber has refractory packing.

A fundamental feature of bubbling layer processes that provides for their high technical and economic performance is the maximally developed charge/molten glass phase boundary due to the elimination of charge piles from the glass melting bath surface, its loading to the mixed layer in the form of an uninterrupted flow, an extremely high bulk heat load and intense convective heat and mass exchange. Combined with the large phase boundary area, this determines the high output to raw material performance of bubbled layer furnaces.

The high molten glass layer temperature and intense gas bubbling develop favorable conditions for the dissolution of refractory charge components. Intense melt mixing provides for the homogenization of its chemical composition.

The high bulk heat loads allow minimizing the working volume and furnace size for the preset output. Further requirement to the design of bubbled layer furnaces related to the high heat loads and intense bath mixing is the replacement of refractory lining in the furnace working space for water cooled metallic caissons with refractory packing. This replacement provides for durable and reliable furnace service life without walls overhauls. The large amounts of heat removed from the working chamber are delivered for heat recovery. High temperature off-gases released from the furnace are also delivered for heat recovery.

### BRIEF DESCRIPTION OF THE DRAWINGS

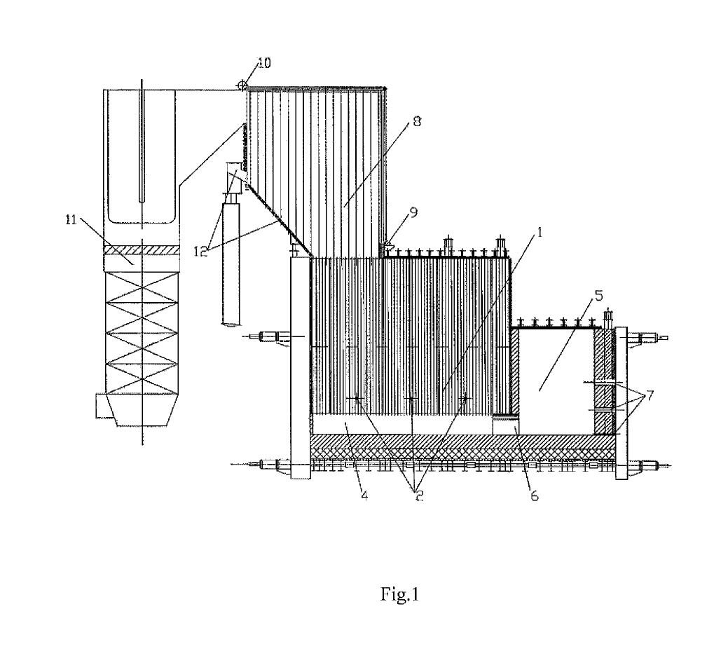

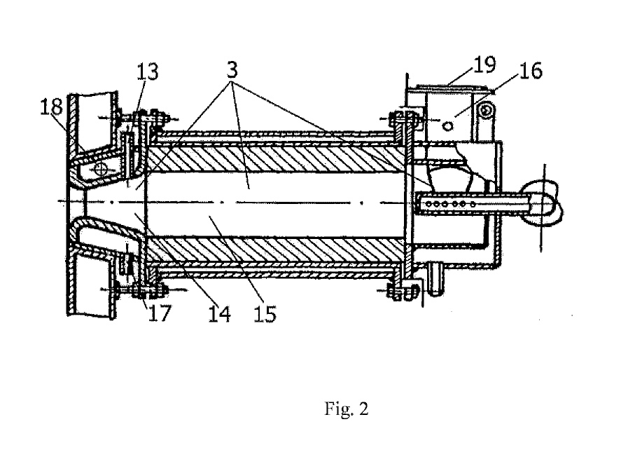

The invention is explained with drawings where FIG. 1 shows a general view of the bubbled molten glass layer glass furnace and FIG. 2 shows a general view of the combustion chamber,

The drawing shows the following units and components of the glass furnace: molten glass layer bubbling first chamber 1, tuyers 2 for the delivery of fuel combustion products and dust charge fraction to the molten glass layer, fuel combustion chamber 3, second chamber 4, third chamber 5, overflow channel 6 between chambers 4 and 5, molten glass discharge unit 7, off gas cooling and primary cleaning chamber 8, radiation air heater input manifold 9, radiation air heater output manifold 10, heat recovery boiler 11, large charge fraction loading unit 12, unit 13 for the delivery of dust charge fraction to the nozzle, fuel combustion chamber 3 nozzle 14, fuel combustion chamber 3 working chamber 15, fuel combustion chamber 3 mixer 16, combustion chamber nozzle water delivery port 17, combustion chamber nozzle water discharge port 18 and combustion chamber mixer air delivery port 19.

### EMBODIMENTS OF THE INVENTION

The method of glass melting using the molten glass layer bubbling glass melting furnace is as follows.

The glass melting process can be divided into five stages: silicate formation, glass formation, homogenizing, degassing and cooling.

The silicate formation stage comprises melting of the fusible charge components and the completion of all the chemical reactions in the primary melt. at the end of this stage all the main oxides contained in the charge are bound with silica in the form of silicates. Silicate formation rate can be increased by earlier generation of the liquid phase in the charge. This is favored by increasing the charge/molten glass phase boundary area, high heat concentration in the unit volume of the media surrounding the melting charge, increasing the charge temperature in the melting zone (increasing charge temperature by 100-150° C. accelerates silicate formation twofold) and intensifying the mixing of the melting charge with its surrounding media.

The glass formation stage comprises the dissolution of the quartz grains remaining in the initial melt (some 25% of charge quartz not bound into silicates remains in the melt after the completion of the first stage). The dissolution involves mass exchange between silicic acid forming on the surface of silica particles with the surrounding molten glass. The diffusion boundary layer forming on the particle surfaces hinders the mass exchange. To accelerate glass formation which takes some 60% of the total glass melting time one should minimize the thickness of the diffusion boundary layer on the surface of silica particles. This can be achieved by reducing the viscosity and surface tension of the primary melt i.e. by increasing its temperature and maximally intensifying its mixing.

Homogenizing provides for a uniform chemical composition of the molten glass in the entire bath volume. This stage also eliminates reams (molten glass portions the chemical composition of which differs from the bath average one. reams in molten glass cause ware rejection e.g. due to higher glass brittleness.

To accelerate homogenization one should increase molten glass temperature and intensify its mixing.

Degassing removes visible gas inclusions from the molten glass. Degassing rate can be increased by increasing molten glass temperature which reduces its viscosity and reducing the partial pressure of the gas components removed from the molten glass in the space above the degassed molten glass layer.

During cooling, molten glass temperature decreases to the level providing the viscosity required for glassware fabrication. Depending on glass type, molten glass temperature is decreased by 150-300° C. During cooling one should bear in mind the molten glass tendency to crystallize in a specific temperature range to avoid this process and provide gradual and homogeneous molten glass cooling without sharp temperature gradients in its bulk.

The glass furnace is a rectangular section device the working space of which is divided into three process areas.

The first silicate formation, glass formation and homogenizing process area is a rectangular chamber 1 for molten glass layer bubbling filled with molten glass layer to the working level blown with high temperature combustion products.

Large charge fractions are continuously loaded into chamber 1 in the space above the layer via the sloped gravity slide of device 12. The sloped gravity slide is in the form of a forced cooled metallic structure with refractory packing at the working side. During the movement along said sloped gravity slide and further free falling to the bubbled molten glass layer the charge particles are heated to 650° C. due to radiation and convective heat exchange.

The large charge fraction loading device 12 is installed at the butt wall of chamber 8 opposite to chamber 5.

The outer side of the side walls in the bottom part of chamber 1 has at least 1 horizontal tuyer 2 for the delivery of fuel combustion products and dust charge fraction to the molten glass layer. Each tuyer 2 has fuel combustion chamber 3 at its outer side that provides for controlled combustion of gaseous fuel.

Chamber 3 consists of nozzle 14, working chamber 15 and mixer 16 and is water cooled.

Water delivery 17 to and discharge 18 from said nozzle are separate from the rest of chamber 3. The delivery 19 of heated air to mixer 16 is tangential which improves the mixing of gas components.

Dust charge fractions are delivered separately from large fractions to directly under the bubbled layer via tuyers 2 with the flow of combustion products. These fractions are delivered to tuyers 2 with pneumatic device 14 via nozzle 14 of chamber 3.

Chamber 3 has refractory packing inside that provides for its reliable operation at temperatures below 2400° C.

The walls of chamber 1 are in the form of tubular metallic caissons with forced cooling and protective refractory packing at the working side.

The first process section is intended for the silicate formation, glass formation, charge dissolution and melting and homogenizing processes. The maximum possible bulk heat density for the preset temperature is developed in the molten glass bubbling layer. This is achieved by blowing the molten glass with high temperature combustion products of gaseous fuel. The theoretical combustion product temperature at the bubbled layer input is accepted to be 1750° C. As the bulk heat content of the gases is at least three orders of magnitude lower than the of the molten glass due to the different densities of the gases and the molten glass (ρ_{g1}=2274 kg/m³ vs ρ_{g(1750)}=0.27 kg/m³), the hot gases contacting the molten glass will transfer their excessive heat to the molten glass and almost immediately acquire the temperature equal to that of the molten glass. The theoretical molten glass temperature will be 1500° C. at any point of the bath volume. A homogeneous molten glass temperature distribution in the bath volume is due to the perfect mixing operation mode of the furnace in the molten glass layer bubbling zone. The perfect mixing achieved in the bubbled layer provides for not only a homogeneous bulk temperature distribution but also for an absolutely homogeneous bulk chemical composition of the molten glass. This prevents ream formation and ensures a homogeneous distribution of all the charge fractions in the bath volume. Thus, the molten glass bubbling layer provides the maximally auspicious conditions for the main glass melting processes.

The second degassing process area consists of two chambers 4 and 5. Chamber 4 is located under chamber 1, and chamber 5 is a forehearth adjacent to one of the butt walls of chamber 1.

Chambers 4 and 5 are interconnected with overflow channel 6 located in the furnace bottom. Chamber 5 is equipped with molten glass discharge unit 7. Furnace output molten glass temperature is controlled by adjusting the time of its presence in the degassing area by varying the height of the discharge ports.

The walls of chambers 4 and 5 are made from refractory materials. This process area does not provide for intense molten glass mixing, and molten glass cannot be delivered to the bubbled layer.

Molten glass from chamber 1 is delivered down to the degassing area where conditions for intense release of the gaseous phase therefrom are developed. This is due to the fact that the static pressure in the degassing area is higher than in the molten glass bubbling layer and above its surface. Accordingly, this area has favorable conditions for gaseous phase transfer to the molten glass bubbling layer and further to chamber 8.

The third off gas cooling and primary cleaning process area comprises chamber 8 located above chamber 1 and interconnected therewith. This are also comprises the top portion of chamber 1 free from the molten glass layer. The third area is intended for the separation of the drops removed from the molten glass bubbling layer, heating large charge fractions delivered to the furnace and heating the air delivered for fuel combustion. The molten glass bubbling layer off gases at a temperature of 1500° C. pass through the space above the molten glass layer and are delivered to the heat recovery boiler with a temperature of 1110° C. where they are finally cooled down to the off gas temperature which is 220° C.

The walls of chamber 8 consist of tubular metallic caissons with forced cooling and protective refractory packing at the working side.

The tubular metallic caissons of chamber 8 that form its ceiling and butt wall facing said chamber 5 are combined into a radiation air heater in which input manifold 9 is connected to the air blower and output manifold 10 is connected to air ducts 19 of mixers 16 of chamber 3.

The heat recovery boiler connected to the output of chamber 8 is installed outside the furnace at the side of chamber 8.

The use of the energy saving molten glass layer bubbling glass melting furnace according to this invention allows increasing furnace output and stabilizing the physical properties of the molten glass due to an increased temperature in the glass melting space of the furnace and intensified mixing of the molten glass layer.

What is claimed is a:

1. Molten glass layer bubbling glass melting method comprising melting the glass layer in the first chamber of the furnace to the working level, further uninterrupted loading of large and small charge portions into the molten glass layer with simultaneous intense bubbling of the molten glass layer with high-temperature combustion products aiming at the formation of the maximum possible charge/molten glass phase boundary area and achieving a molten glass temperature of at least 1500° C., which conditions intensify the melting, silicate formation, vitrification and homogenizing processes, delivery of the chemically and thermally homogeneous molten glass produced by bubbling to the degassing and cooling section located under the bubbled molten glass layer, with an intense release from the molten glass layer of process gases that pass through the bubbled layer to the space above the layer where the process gases undergo primary cleaning and cooling, and the degassed molten glass is delivered to the further output section.

2. Molten glass bubbling glass furnace having a wall limited working space that is rectangular in cross-section and is separated into the first chamber which at the outer side of the side walls in its bottom part has horizontal tuyers for the delivery of fuel combustion products and dust charge fraction, wherein each tuyer has a fuel combustion chamber at its outer side, the walls of the first chambers are in the form of tubular metallic caissons with forced cooling and protective refractory packing at the working side, the second chamber is located under said first chamber, and the third chamber is adjacent to one of the butt side walls of said first chamber from the outside, said second and third chambers are interconnected with an overflow channel located in the furnace bottom section, said third chamber is equipped with a molten glass discharge unit, the walls of said second and third chambers are made from refractory materials, above said first chamber, there is the fourth chamber interconnected with said first chamber, its walls consisting of tubular metallic caissons with forced cooling and protective refractory packing at the working side, the tubular metallic caissons of said fourth chamber that form its ceiling and butt wall facing said third chamber are combined into a radiation air heater in which the input manifold is connected to an air blower and the output manifold is connected to the air ducts of combustion chamber mixers, a heat recovery boiler connected to the output of the fourth chamber is installed outside the furnace at the side of the fourth chamber, a device for loading large charge fractions into the first chamber is installed at the butt wall of the fourth chamber opposite to the third chamber, said device being equipped with a sloped gravity slide in the form of a forced cooled metallic structure with refractory packing at the working side.

3. Glass furnace of claim 1 wherein said tuyers for the delivery of fuel combustion products and dust charge fraction to the molten glass layer are connected to the pneumatic transporter for the delivery of dust charge fraction.

4. Glass furnace of claim 1 wherein said fuel combustion chamber comprises a nozzle, a working chamber and a mixer and is water cooled.

5. Glass furnace of claim 3 wherein water delivery to and discharge from said nozzle are separate from the rest of said fuel combustion chamber, and the delivery of heated air to the mixer is tangential.

6. Glass furnace of claim 3 wherein said combustion chamber has refractory packing inside.
